(19) United States
(12) Patent Application Publication
(10) Pub. No.: US 2016/0098931 A1
(43) Pub. Date: Apr. 7, 2016

(54) SYSTEM FOR ESTABLISHING A BEHAVIORAL ROUTINE

(71) Applicant: Penni L. Sears, Truth or Consequences, NM (US)

(72) Inventor: Penni L. Sears, Truth or Consequences, NM (US)

(21) Appl. No.: 14/503,552

(22) Filed: Oct. 1, 2014

(51) Int. Cl. G09B 1/12; G09B 19/00

(52) U.S. Cl. CPC G09B 1/12; G09B 19/00

(57) ABSTRACT

A system comprises a plurality of card units. The card units have a first side, a second side, a hole being positioned proximate a top of the card unit, and dimensions for resting on a palm of a user. The card units have indicia on the first sides and the second sides. The indicia is configured to convey behavioral messages to the user. The card units have a texture applied to at least a one of the sides. The texture is configured to convey a tactile stimulation to the user. A ring device retains the card units in an order. The ring device passes through the holes the card units, wherein the ring device enables the user to flip through the card units and receive the behavioral messages for assisting the user in establishing a routine.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to behavior modification and routine development. More particularly, the invention relates to a series of cards, that when combined, create a deck with prompts and messages to help the user develop a routine to help change attitudes, perceptions, thoughts, and behaviors.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

In many instances, people may seek different devices and/or methods to help stimulate and encourage behavior traits commonly found in those populations suffering from behavioral disorders including autism, dementia, and developmental delay. Some currently available solutions may provide a flat stock device as a teaching tool or may provide a device comprised with of a representation of the target subject matter. However, these solutions are not specific to therapeutic or non-therapeutic behavior modifications using a device to help encourage through developing a routine and sending positive and empowering messages to the user. Moreover, these available solutions may not have the means of customization, devices selected by the consumer via a website or generalized set, or to utilize the device as a flip chart with two sides that may consist of shapes and/or textures and with raised letters and/or images that may be flipped throughout the day.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. One such aspect of the prior art is a small-card organizer (“organizer”) that fits into a notebook binder and that enables users to organize and transport card materials, especially educational flashcards. Regarding the educational aspect, another generally useful aspect of the prior art is that of an aid for children/adults/second-language learners who are learning to read and write English. This aid comprises a single- or double-sided card that features one or more words within ruled guidelines and that correspond to real-object images. Another aspect of the prior art is a visual-learning system, which includes at least one card with a representation of the target subject matter, and at least one detachable word-cue card affixed to the target picture card; the word-cue card has at least one word that describes at least one aspect of the target subject matter. However, these solutions may not allow the user to customize, or to generalize, the card set as a device to encourage routine, so that the user may flip the device throughout the day, beginning in the AM and ending in the PM, which may reduce symptoms or undesirable behaviors. A solution which did so would be desirable.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which

FIG. 1 illustrates an exemplary device that assists individuals, with varying impairment levels of therapeutic and non-therapeutic behaviors and disorders, to establish routines through the use of customizable or generalized cards, in which FIG. 1A is a front view, FIG. 1B is a back view, FIG. 1C is a side view, and FIG. 1D is a front view of a one sided card in accordance with an embodiment of the present invention;

FIG. 2 illustrates a side view of an exemplary device that may be used to form deck, in accordance with an embodiment of the present invention;

FIG. 3 illustrates a system of exemplary device, that form a deck, as shown by example in FIGS. 3A, 3B, 3C, 3D, 3E, and 3F, in accordance with an embodiment of the present invention;

FIG. 4 illustrates a flow chart of an exemplary method that may use a device (such as, without limitation, card deck 140 of FIG. 1) to selectively employ prompts and messages to help the user develop a routine to help change attitudes, perceptions, thoughts, and behaviors, in accordance with an embodiment of the present invention;

FIG. 5 illustrates exemplary tags, as shown by example in FIGS. 5A, 5B and 5C, in accordance with an embodiment of the present invention;

FIG. 6 illustrates exemplary fasteners, as shown by example in FIGS. 6A and 6B, in accordance with an embodiment of the present invention; and

FIG. 7 illustrates exemplary straps, as shown by example in FIGS. 7A and 7B, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

Headings provided herein are for convenience and are not to be taken as limiting the disclosure in any way.

The enumerated listing of items does not imply that any or all of the items are mutually exclusive, unless expressly specified otherwise.

The terms “a”, “an” and “the” mean “one or more”, unless expressly specified otherwise.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Some embodiments of the present invention may be suitable for varying ages and behavior levels; thus, changing the raised and lower effect or the customized slogans on the device, including, without limitation, those customized or generalized for children, adults, or the elderly.

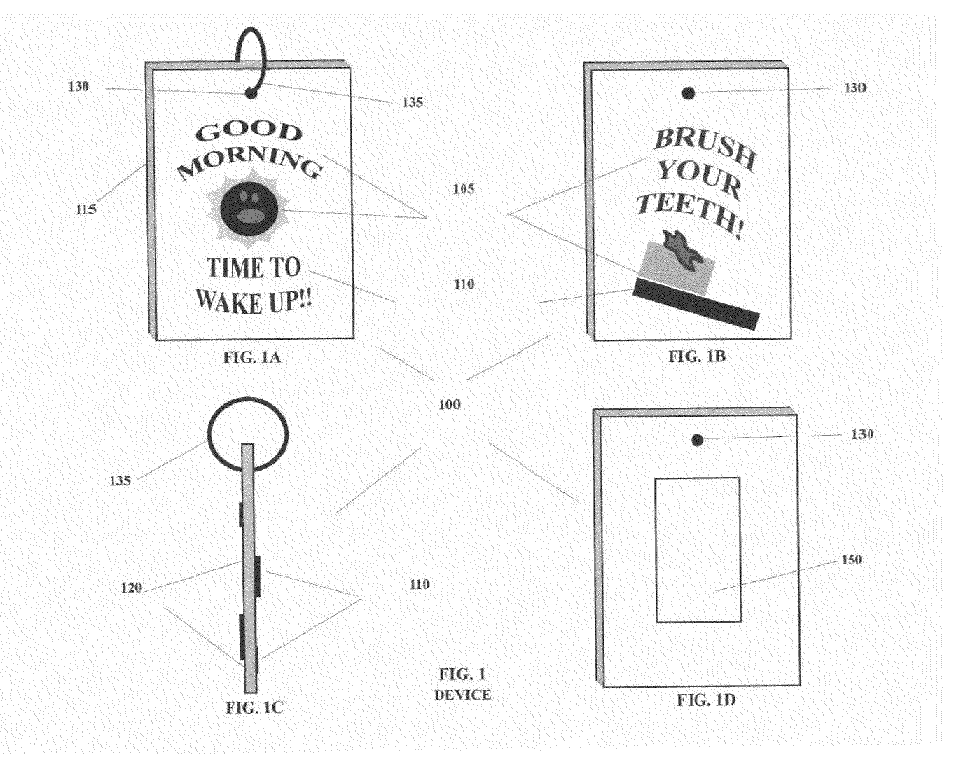

FIG. 1 illustrates an exemplary device 100 that assists individuals with various impairment levels of therapeutic and non-therapeutic behaviors and disorders to establish routines through the use of customizable or generalized cards, in which FIG. 1A is a front view, FIG. 1B is a back, and FIG. 1C is a side view, in accordance with an embodiment of the present invention. In the present embodiment, device 100 may have two sides, FIG. 1A and FIG. 1B. In some alternative embodiments, device 100 may be single sided, FIG. 1D. In the present embodiment, device 100 may have a prompt or image association 105 attached to device 100 to assist the user. In a non-limiting example, the prompt or image association 105 may be suited to the user, including, without limitation, as a chores reminder or as a positive message. In another non-limiting example, device 100 may include prompt 105 with a picture of a toothbrush and the words “Brush your teeth.” In the present embodiment, device 100 may have raised words or images 110 that thereby create recesses 120. In some embodiments, words or images 110 are raised to create textures, thereby creating textured recesses 120 for the user to feel. In a non-limiting example, the toothbrush prompt 105 of device 100 may be raised 110 to stimulate the user and to create an association between the prompt and the picture. In another non-limiting example, on device 100, the prompt 105 and texture 110 may be created with decorative paper, cardstock, and cardboard by glueing the letters,words, and images to device 100. In yet another non-limiting example, device 100 may have cutouts 150 to create desired prompts 105 and textures 110 and 120. In another non-limiting example, raised textures 110 may contain general surface types like bumpy, spikes, needles, mesh, geometric shapes, and Braille. In the present embodiment, device 100 consist of a suitable material with a thickness 115 that permits a weighty, clacking sound when multiple devices 100 are stacked. In a non-limiting example, a single device 100 may be 2⅝ inches in length, 3⅝ inches in width, with a ⅛ inch thick plank. In another non-limiting example, suitable materials for device 100 may include, without limitation, wood, plastic, plastic molding, acrylic, metal, and fiberglass. In some embodiments, device 100 may be covered by any suitable material that is safe for humans and pets and that protects and promotes the durability of the prompt or image 105, the raised words or images 110 and the recesses 120. In another non-limiting example, suitable materials for device 100 protection may include lamination with decoupage or a polyurethane coating. In the present embodiment, device 100 may include a hole 130 so that multiple devices 100 may be connected together. In some embodiments, device 100 may be connected by using a ring 135 through hole 130. In a non-limiting example, ring 135 may be plastic, metal, or any material that is safe and durable to hold a various number of devices 100.

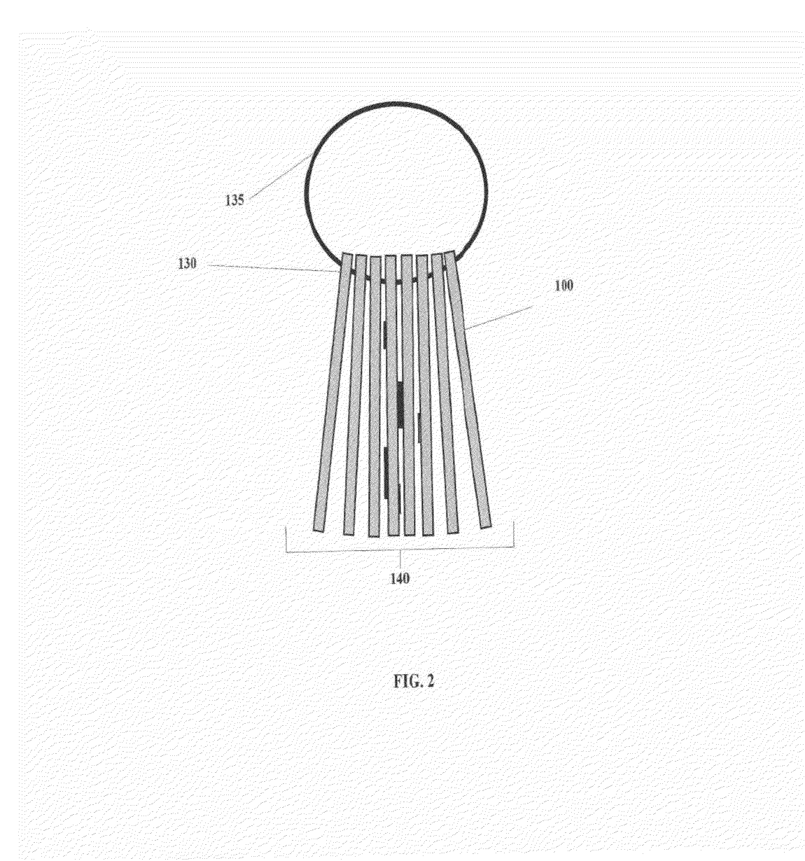

FIG. 2 illustrates the side view of multiple devices 100, connected by ring 135 through hole 130 to form a deck 140, in accordance with an embodiment of the present invention.

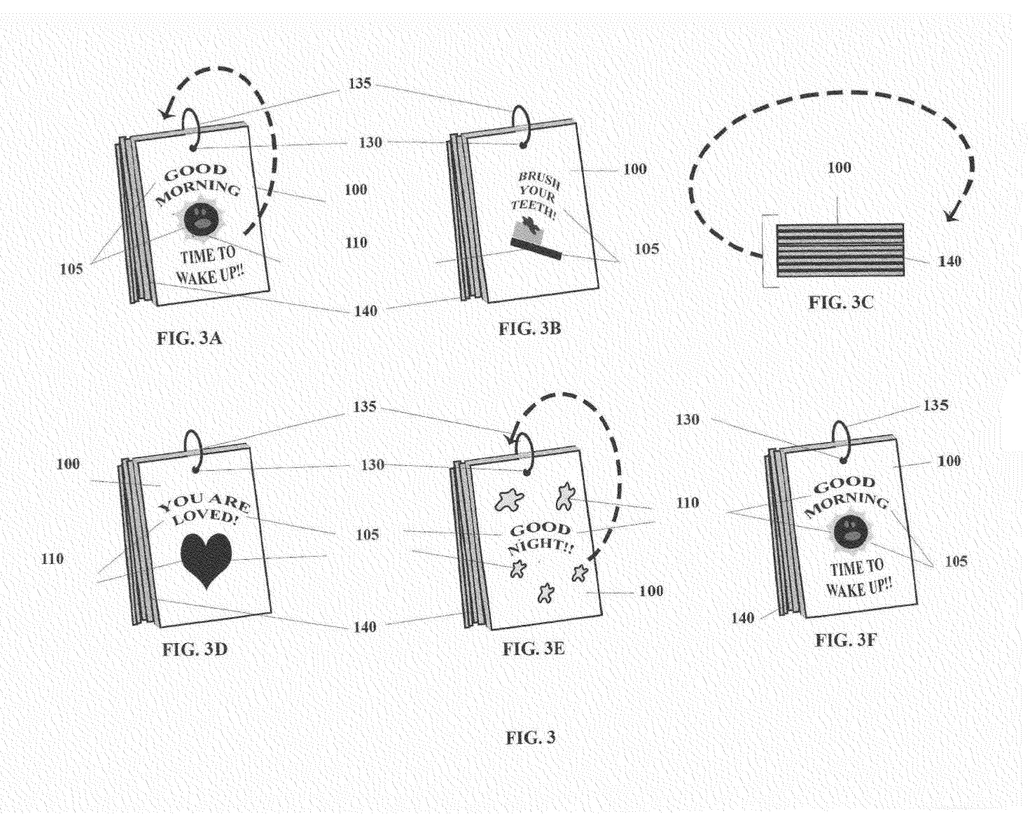

FIG. 3. illustrates a system of exemplary devices that may form a deck, in accordance with an embodiment of the present invention. The system of multiple devices 100 may form a deck 140, which then may be used from morning at wake up until evening at bedtime in order to establish routine and send positive messages. FIG. 3A illustrates deck 140 being flipped in a forward motion to display the front of device 100 beginning in morning; FIG. 3B illustrates a new device 100 with may have a different prompt 105, or may have a different raised letter to picture 110, and may have a different recesses 120; FIG. 3C illustrates the last front side of device 100 and the end of deck 140; FIG. 3D illustrates deck 140 rotating to back side of device 100 which may have a new prompt 105, may have a new raised letter or picture 110, and may have a new recesses 115; FIG. 3E illustrates the last device 100 in deck 140; and FIG. 3F illustrates the return to the beginning on the front side of device 100 and deck 140, in accordance with an embodiment of the present invention. In the present embodiment, deck 140 is a system of assembled device 100 on a ring 135 and may contain as many devices 100 as the user needs. In a non-limiting example, deck 140 may include between eight ten and twenty devices 100 to encourage daily routine, to promote coping skills, to provide encouragement and structure that when internalized, may reduce symptoms/undesirable behaviors. In another nonlimiting example, while the deck 140 is meant to promote routine, the deck may also occupy the user and provide stimulation. In another non-limiting example, device 100 may be selected by consumer on website/catalog and personalized such as, but not limited to, with customized with name, personal information, or photos. In another non-limiting example, device 100 may be purchased in generalized sets such as, but not limited to, that target different ages, genders, disorders and impairment levels.

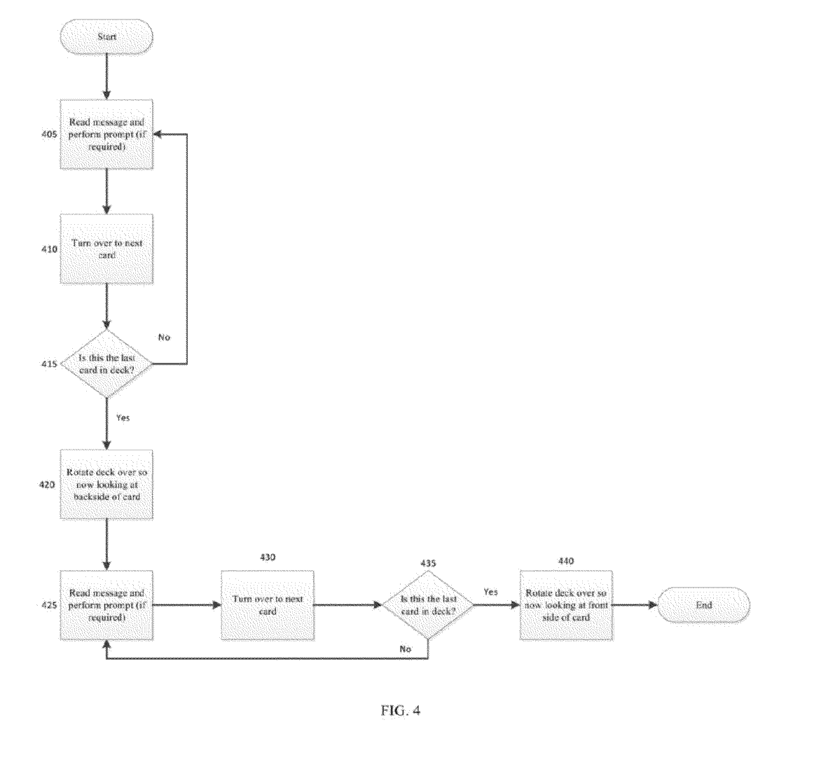

FIG. 4 illustrates a flow chart of an exemplary method that may use a device such as, without limitation, card deck 140 of FIG. 1 to selectively employ prompts and messages to help the user develop a routine to help change attitudes, perceptions, thoughts, and behaviors, in accordance with an embodiment of the present invention. In the present exemplary method embodiment shown, and additionally referring again to FIGS. 1 and 2, in a step 405, the user begins at the first device 100, typically in the morning, in which device 100 may be in the form of a message to establish routine or to send the user a positive message. In a non-limiting example, the message may be to brush their teeth. After the user completes the task or message as indicated, in a step 410 the user then flips device 100 in a forward motion to display the front view of a new device 100. The user then repeats steps 405 and 410 until the user reaches the end of the deck, at a step 415. Then, the user will rotate the deck so that the backside of device 100, at step 420 is facing the user and begins the process again. The user will begin on the backside of device 100 in step 425, typically in the same manner as in step 405. After the user completes the task or message as indicated, in a step 430 the user then flips device 100 in a forward motion to display the back view of new device 100. The user will continue to flip through the devices 100, on the backside, at a step 435, until the user reaches the end of the deck, typically at bedtime. The user then again turns the deck over, at a step 440 to begin the process again, typically the next morning.

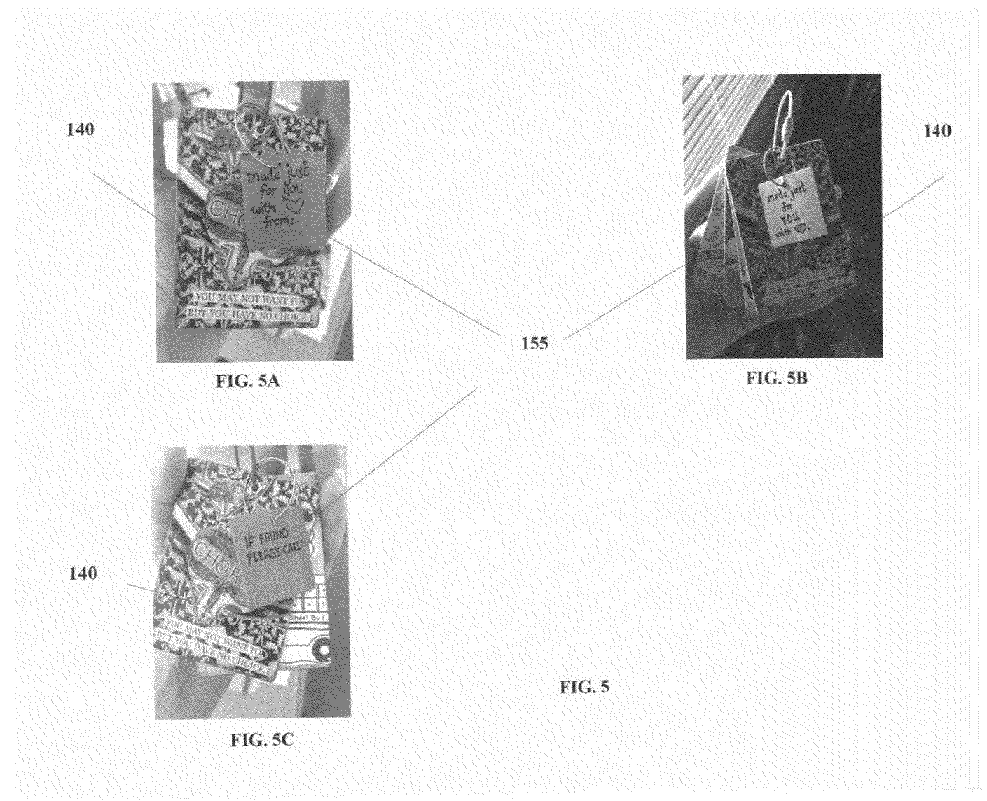

FIG. 5 illustrates exemplary tags, as shown by example in FIGS. 5A, 5B and 5C, in accordance with an embodiment of the present invention. Tag 155 may be attached to deck 140. Tag 155 may include a message and space where personal information may be written. Tag 155 may be made of, without limitation, plastic, metal, wood or other materials that are safe for users.

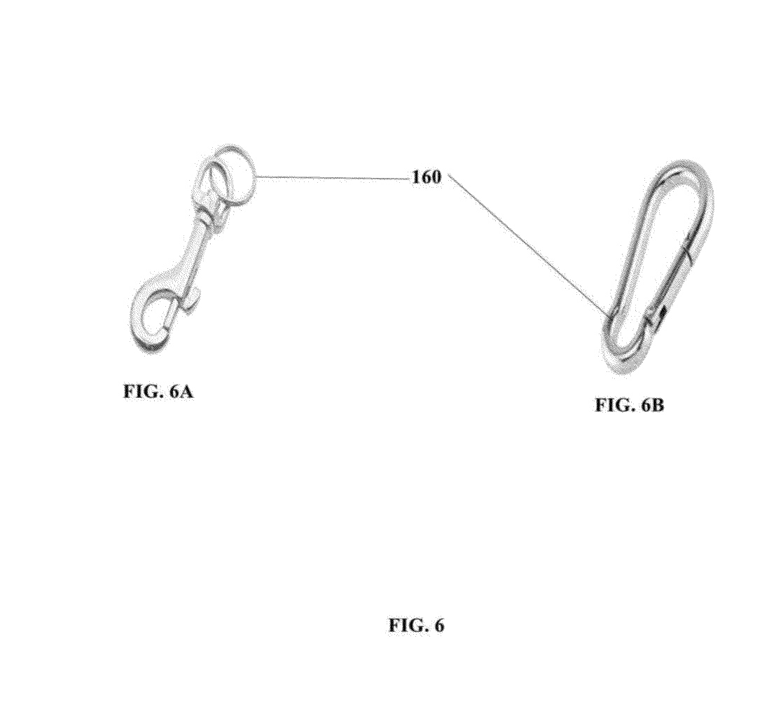

FIG. 6 illustrates exemplary fasteners, as shown by example in FIGS. 6A and 6B, in accordance with an embodiment of the present invention. In some embodiments, device 100 may be attached to fastener 160. In an non-limiting example, fastener 160 may be made out of, without limitation, a metal or plastic clip that may attach to ring 135 and then be connected to an article such as, but not limited to, a belt loop, purse strap, backpack, etc.

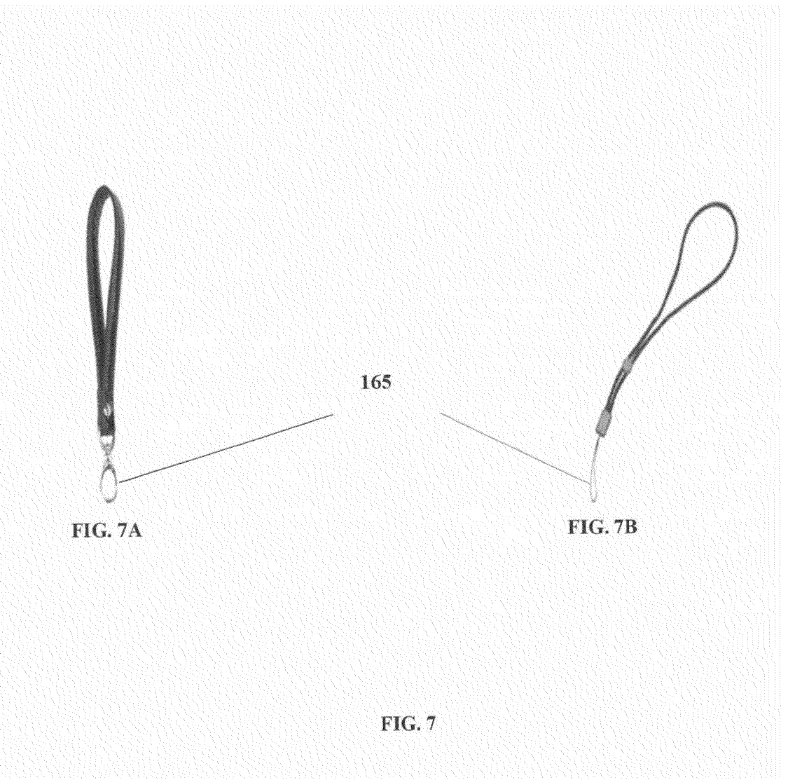

FIG. 7 illustrates exemplary straps, as shown by example in FIGS. 7A and 7B, in accordance with an embodiment of the present invention. In some embodiments, device 100 may be attached with to strap 165. In an non-limiting example, strap 160 may attach to ring 135 and then be used as a means to carry device 100.

In some embodiments of device 100, prompts 105 and images 110 could be made in different languages, sizes, colors, materials, and made for different cultures.

In some embodiments, device 100 may be bound to form deck 140 in various ways. In a non-limiting example, ring 135 may be comprised of various types including a carabineer type or lock type as long as ring is strong enough to securely hold deck 140 and multiple devices 100 and to provide stability.

In some embodiments, deck 100 may focus on prompting 105 specific goals. In a non-limiting example, device 100 may have prompt 105 and texture 110 without the traditional prompts that move consecutively from AM to PM but instead focus on empowering thoughts including “you are loved” or “try your best.” In an additional non-limiting example, device 100 may contain prompts 105 and texture 110 that target specific behaviors for instance, no biting and be nice to animals. In another non-limiting example, device 100 may target specific age groups, for instance the geriatric age suffering from dementia with the prompt “you have dementia, you are loved, your family cares about you.”

In another embodiment, device 100 may be used as a learning tool to help the user make associations to promote learning. In a non-limiting example, device 100 may be used for prompt 105 of sandy, paired with a texture 110 of sand on card. In another non-limiting example, device 100 may be used for prompt 105 of a walnut shell, rocks, and sand paper paired with the matching texture 110 on device.

In another embodiment, device 100 may comprise different sizes and shapes to differentiate subjects. In a non-limiting example, device 100 size may be long and skinny, others may be square, etc., allowing for quick access and differentiation of subjects.

In some embodiments, device 100 may be used for simple communication. In a non-limiting example, device 100 may have prompt 105 and texture 110 stating things like “yes/no”, or “I need” and representations of needs such as water, rest, or bathroom.

In another embodiment, device 100 may be offered as a self-service package to allow the user or family to build device 100 and deck 140 at home. In a non-limiting example, a package may contain everything necessary to construct device 100 such as the wood, images, letters, etc.

In an alternative embodiment, multiple devices 100 are joined by two rings 135, and the holes 130 are reinforced with metal grommets.

In an alternative embodiment, images or words may be printed on vinyl material, which may be either attached to a blank device 100 or may be detached as the user's needs change.

In an alternative embodiment, images or words 105, textures 110, and recesses 120 may be interchangeable. In a non-limiting example, a hook-and-loop fastener may be used on device 100 in place of glue to quickly and efficiently change images or words 105, textures 110, and recesses 120. In another non-limiting example, words or images 105, textures 110, and recesses 120 may be slid into prefabricated slots on device 100. In yet another non-limiting example, device 100 may be constructed with a peg-board exterior to quickly interchange words and pictures 105, textures 110, and recesses 120.

In an alternative embodiment device 100 may quickly aid individuals suffering with a stroke or other illness effecting communication or memory. In some embodiments, device 100 may have some blank sections/areas where words, names, address, etc may be written in to quickly to help aid with communication. As a non-limiting example, a message may be “My name is John, I have apashia so my communication may be hard to understand, My wife is Jana, her phone number is: xxx-xxxx. In other alternate embodiments, the cards with blanks can be combined with other cards with inspiring supportive messages Recovery takes time, take one day at a time, at the same time the textures, pictures, colors and ridges would provide stimulation.”

In a alternative embodiment, decks 140 may be formed using thinner devices 100 so that more may be fit onto ring 135 to create larger decks 140. In a non-limiting example, decks 140 may have just feeling words. These may be used to communicate feelings for users that find emotions difficult to express or discuss. This may also be useful in family or couples counseling to see if family partners are on the “same page” emotionally or can recognize emotions in the other individual.

In an alternative embodiment device 100 may be used for users that do not have therapueutic needs but may benefit, without limitation, from repeated reminders, a schedule, stimulation, or inspiring messages such as, but without limitation, young child learning to communicate with parents with the device before language development.

In an alternative embodiment device 100 may be used in therapy as a “prescription” of sorts in cases where the user would benefit from repeated messages or encouragement such as, without limitation, cognitive behavioral therapy, help with a diet, substance abuse, etc. In some embodiments, therapists or other specialty provider may create customized decks for clients or purchase generalized decks. A myriad of different professionals may use the device with their clients such as, but not limited to, special education, counselors, therapists, doctors, nurses, physical and speech therapists, etc.

In an alternative embodiment, using 3-D printing technologies, a user may design and print the cards at home using computer programs. Different backgrounds, images, photos, and texts on a website or through a computer program or application would allow consumers to design and specialize messages specific to the end user.

In an alternative embodiment, device 100 may be used to help people suffering from memory problems. Cards may be created to help stimulate the persons memory such as, but not limited to, using their name, photos of persons home, family, etc.

Those skilled in the art will readily recognize, in light of and in accordance with the teachings of the present invention that any of the foregoing steps may be suitably replaced, reordered, or removed and that additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC §112 (1), all claims must be supported by sufficient disclosure in the present patent specification, and any material known to those skilled in the art need not be explicitly disclosed. However, 35 USC §112 (6) requires that structures corresponding to functional limitations interpreted under 35 USC §112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC §112 (6) when such corresponding structures are not explicitly disclosed in the foregoing patent specification. Therefore, for any invention element(s)/structure(s) corresponding to functional claim limitation(s), in the below claims interpreted under 35 USC §112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC §112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC §112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC §112 (6). Applicant(s) note that all the identified documents above which are incorporated by reference to satisfy 35 USC §112 (6) necessarily have a filing and/or publication date prior to that of the instant application, and thus are valid prior documents to incorporated by reference in the instant application.

Having fully described at least one embodiment of the present invention, other equivalent or alternative methods of implementing behavior modification and routine development according to the present invention will be apparent to those skilled in the art. Various aspects of the invention have been described above by way of illustration, and the specific embodiments disclosed are not intended to limit the invention to the particular forms disclosed. The particular implementation of the behavior modification and routine development may vary depending upon the particular context or application. By way of example, and not limitation, the behavior modification and routine development described in the foregoing were principally directed to a series of cards, that when combined, create a deck implementations; however, similar techniques may instead be applied to a texture learning flip book that can teach the user the words for various textures as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. A system comprising:
a plurality of card units, each of said card units comprising a first side, a second side, a hole being positioned proximate a top of said card unit and dimensions for resting on a palm of a user, said card units further comprising indicia on said first sides and said second sides, said indicia being configured to convey behavioral messages to the user, said card units further comprising a texture being applied to at least a one of said first side and said second side, said texture being configured to convey a tactile stimulation to the user; and
a ring device being configured for retaining said card units in an order, said ring device passing through said hole of each of said card units, wherein said ring device enables the user to flip through said card units and receive said behavioral messages for assisting the user in establishing a routine.

2. The system as recited in claim 1, further comprising a tag unit being configured for joining to said ring device, said tag unit being configured for conveying personal information regarding the user.

3. The system as recited in claim 2, in which said tag unit comprises dimensions smaller than said card units.

4. The system as recited in claim 1, further comprising means for removably joining said ring device to an accessory of the user.

5. The system as recited in claim 1, in which said order is configured for behavioral messages to be sequentially ordered on said first sides and for behavioral messages to be sequentially ordered on said second sides.

6. The system as recited in claim 1, in which said texture further comprises a cutout.

7. The system as recited in claim 1, in which said texture further comprises an additional material joined to a surface of said card unit.

8. The system as recited in claim 1, in which said indicia further comprises images and text.

9. The system as recited in claim 8, in which said texture further comprises a raising of a surface of an image.

10. The system as recited in claim 9, in which said raising of said image forms a recess area on an opposing side of said card unit.

11. The system as recited in claim 8, in which said texture further comprises a raising of a surface of a text.

12. The system as recited in claim 11, in which said raising of said text forms a recess area on an opposing side of said card unit.

13. The system as recited in claim 8, in which said images are associated with said text for conveying a behavioral prompt to the user.

14. The system as recited in claim 1, in which at least one of said behavioral messages comprises a positive message for assisting the user in managing feelings and emotional reactivity.

15. The system as recited in claim 1, in which said behavioral messages are personalized to the user.

16. The system as recited in claim 1, in which said dimensions comprise a length of between three and four inches and a width of between two and three inches.

17. A system comprising:
means for conveying behavioral messages and tactile stimulation to a user, said conveying means being configured for resting on a palm of the user; and
means for retaining said conveying means in an order, wherein said retaining means enables the user to flip through said conveying means and receive said behavioral messages for assisting the user in establishing a routine.

18. The system as recited in claim 17, further comprising means for conveying personal information regarding the user.

19. The system as recited in claim 17, further comprising means for removably joining said retaining means to an accessory of the user.

20. A system comprising:
a plurality of card units, each of said card units comprising a first side, a second side, a hole being positioned proximate a top of said card unit and dimensions for resting on a palm of a user, said dimensions comprising a length of between three and four inches and a width of between two and three inches, said card units further comprising indicia on said first sides and said second sides, said indicia comprising images and text, in which said images are associated with said text for conveying a behavioral prompt to the user, said indicia being configured to convey behavioral messages to the user, in which said behavioral messages are personalized to the user and at least one of said behavioral messages comprises a positive message for assisting the user in managing feelings and emotional reactivity, said card units further comprising textures being applied to said first side and said second side, said textures at least comprising a cutout, an additional material joined to a surface of said card unit, a raising of a surface of an image, in which said raising of said image forms a recess area on an opposing side of said card unit, and a raising of a surface of a text, in which said raising of said text forms a recess area on an opposing side of said card unit, said textures being configured to convey a tactile stimulation to the user;
a ring device being configured for retaining said card units in an order, said ring device passing through said hole of each of said card units, said order being configured for behavioral messages to be sequentially ordered on said first sides and for behavioral messages to be sequentially ordered on said second sides wherein said ring device enables the user to flip through said card units and receive said behavioral messages for assisting the user in establishing a routine;
a tag unit being configured for joining to said ring device, said tag unit said tag unit comprising dimensions smaller than said card units and being configured for conveying personal information regarding the user; and
means for removably joining said ring device to an accessory of the user.
